(19) United States
(12) Patent Application Publication
(10) Pub. No.: US 2009/0046543 A1
(43) Pub. Date: Feb. 19, 2009

(54) IMAGE PROCESSING SYSTEM AND METHOD FOR SILHOUETTE RENDERING AND DISPLAY OF IMAGES DURING INTERVENTIONAL PROCEDURES

(75) Inventors: Thomas Jan De Hoog, Eindhoven (NL); Henricus Renatus Martinus Verberne, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,832

(22) PCT Filed: Nov. 7, 2006
(86) PCT No.: PCT/IB2006/054131

§ 371 Date: May 7, 2008

(30) Foreign Application Priority Data
Nov. 11, 2005 (CN) 200510119487.6

(51) Int. Cl. G11B 7/085

(52) U.S. Cl. 369/30.03; G9B/7.042

(57) ABSTRACT

A positioning system in an optical card reading apparatus, for accurately positioning the optical card (801) relative to the probe array (102) used to read the data stored on the card. The card (801) is provided with a pattern of servo bands (800) and the sensor (103) used to read out data stored on the optical card (801) has a windowing function which is used to narrow its field of view (802) to define a region of interest (900) corresponding to one or the servo bands (800), and the output is fed to an analogue-to-digital converter. Thus, the “windowing” function of the sensor (103) is used to increase the readout speed and, therefore, the speed of detection of servo marks (800) to enable more rapid positioning of the probe array (102) relative to the optical card (801).

### FIELD OF THE INVENTION

The invention relates to a system and method for positioning an information carrier in a scanning apparatus.

The invention has applications in the field of optical data storage and microscopy.

### BACKGROUND OF THE INVENTION

The use of optical storage solutions is nowadays widespread for content distribution, for example in storage systems based on the DVD (Digital Versatile Disc) standards. Optical storage has a big advantage over hard-disc and solid-state storage in that the information carriers are easy and cheap to replicate.

However, due to the large amount of moving elements in the drives, known applications using optical storage solutions are not robust to shocks when performing read/write operations, considering the required stability of said moving elements during such operations. As a consequence, optical storage solutions cannot easily and efficiently be used in applications which are subject to shocks, such as in portable devices.

New optical storage solutions have thus been developed. These solutions combine the advantages of optical storage in that a cheap and removable information carrier is used, and the advantages of solid-state storage in that the information carrier is still and that its reading requires a limited number of moving elements.

FIG. 1 depicts a three-dimensional view of system illustrating such an optical storage solution.

This system comprises an information carrier 101. The information carrier 101 comprises a set of square adjacent elementary data areas having size referred to as s and arranged as in a matrix. Data are coded on each elementary data area via the use of a material intended to take different transparency levels, for example two levels in using a material being transparent or non-transparent for coding a 2-states data, or more generally N transparency levels (for example N being an integer power of 2 for coding a ²log(N)-states data).

This system also comprises an optical element 104 for generating an array of light spots 102 which are intended to be applied to said elementary data areas.

The optical element 104 may correspond to a two-dimensional array of apertures at the input of which the coherent input light beam 105 is applied. Such an array of apertures is illustrated in FIG. 2. The apertures correspond for example to circular holes having a diameter of 1 μm or much smaller.

The array of light spots 102 is generated by the array of apertures in exploiting the Talbot effect which is a diffraction phenomenon working as follows. When a coherent light beam, such as the input light beam 105, is applied to an object having a periodic diffractive structure (thus forming light emitters), such as the array of apertures, the diffracted lights recombines into identical images of the emitters at a plane located at a predictable distance z0 from the diffracting structure. This distance z0 is known as the Talbot distance. The Talbot distance z0 is given by the relation z0=2.n.d²/λ, where d is the periodic spacing of the light emitters, λ is the wavelength of the input light beam, and n is the refractive index of the propagation space. More generally, re-imaging takes place at other distances z(m) spaced further from the emitters and which are a multiple of the Talbot distance z such that z(m)=2.n.m.d²/λ, where m is an integer. Such a re-imaging also takes place for m=½+an integer, but here the image is shifted over half a period. The re-imaging also takes place for m=¼+an integer, and for m=¾+an integer, but the image has a doubled frequency which means that the period of the light spots is halved with respect to that of the array of apertures.

Exploiting the Talbot effect allows generating an array of light spots of high quality at a relatively large distance from the array of apertures (a few hundreds of μm, expressed by z(m)), without the need of optical lenses. This allows inserting for example a cover layer between the array of aperture and the information carrier 201 for preventing the latter from contamination e.g. dust, finger prints . . . ). Moreover, this facilitates the implementation and allows increasing in a cost-effective manner, compared to the use of an array of micro-lenses, the density of light spots which are applied to the information carrier.

Each light spot in intended to be successively applied to an elementary data area. According to the transparency state of said elementary data areas, the light spot is transmitted (not at all, partially or fully) to a CMOS or CCD detector 103 comprising pixels intended to convert the received light signal, so as to recover the data stores on said elementary data area.

Advantageously, one pixel of the detector is intended to detect a set of elementary data, said set of elementary data being arranged in a so-called macro-cell data, each elementary data area among this macro-cell data being successively read by a single light spot of said array of light spots 102. This way of reading data on the information carrier 101 is called macro-cell scanning in the following and will be described after.

FIG. 3 depicts a partial cross-section and detailed view of the information carrier (101, and of the detector 103).

The detector 103 comprises pixels referred to as PX1-PX2-PX3, the number of pixels shown being limited for facilitating the understanding. In particular, pixel PX1 is intended to detect data stored on the macro-cell data MC1 of the information carrier, pixel PX2 is intended to detect data stored on the macro-cell data MC2, and pixel PX3 is intended to detect data stored on the macro-cell data MC3. Each macro-cell data comprises a set of elementary data. For example, macro-cell data MC1 comprises elementary data referred to as MC1a-MC1b-MC1c-MC1d.

FIG. 4 illustrates by an example the macro-cell scanning of the information carrier 101. For facilitating the understanding, only 2-states data are considered, similar explanations holding for an N-state coding. Data stored on the information carrier have two states indicated either by a black area (i.e. non-transparent) or white area (i.e. transparent). For example, a black area corresponds to a “0” binary state while a white area corresponds to a “1” binary state.

When a pixel of the detector 103 is illuminated by an output light beam generated by the information carrier 101, the pixel is represented by a white area. In that case, the pixel delivers an electric output signal (not represented) having a first state. On the contrary, when a pixel of the detector 103 does not receive any output light beam from the information carrier, the pixel is represented by a cross-hatched area. In that case, the pixel delivers an electric output signal (not represented) having a second state.

In this example, each macro-cell data comprises four elementary data areas, and a single light spot is applied simultaneously to each set of data. The scanning of the information carrier 101 by the array of light spots 102 is performed for example from left to right, with an incremental lateral displacement which equals the period of the elementary data areas.

In position A, all the light spots are applied to non-transparent areas so that all pixels of the detector are in the second state.

In position B, after displacement of the light spots to the right, the light spot to the left side is applied to a transparent area so that the corresponding pixel is in the first state, while the two other light spots are applied to non-transparent areas so that the two corresponding pixels of the detector are in the second state.

In position C, after displacement of the light spots to the right, the light spot to the left side is applied to a non-transparent area so that the corresponding pixel is in the second state, while the two other light spots are applied to transparent areas so that the two corresponding pixels of the detector are in the first state.

In position D, after displacement of the light spots to the right, the central light spot is applied to a non-transparent area so that the corresponding pixel is in the second state, while the two other light spots are applied to the transparent areas so that the two corresponding pixels of the detector are in the first state.

Elementary data which compose a macro-cell opposite a pixel of the detector are read successively by a single light spot. The scanning of the information carrier 101 is complete when the light spots have each been applied to all elementary data area of the macro-cell data facing a pixel of the detector. This implies a two-dimensional scanning of the information carrier.

To read the information carrier, a scanning of the information carrier by the array of light spots is done in a plane parallel to the information carrier. A scanning device provides translational movement of the light spots in the two directions x and y for scanning all the surface of the information carrier.

The system described above has been proposed for use in an optical card storage concept that aims to combine certain advantages of solid-state storage with those of optical storage. It is a robust system (because there are few or no moving parts), in a small form-factor like solid-state memory, but it also has a removable medium that can be replicated cheaply, like traditional optical storage media. The system is envisaged to be of ROM (read only memory) type and suitable for (cheap) content distribution. The information carrier may comprise a data card envisaged to be manufactured in the form of a CD, DVD, etc) by the process of mass replicable polycarbonate injection moulding.

FIG. 5 depicts a partial top view of a known system exploiting the Moiré interference effect for the generation of servo (position information) in the T-ROM system. This information is needed in order to align the probe array with the bit marks on the medium, and depending on the position error between spot and track an error signal is generated on the detector and processed by a servo controller, which repositions the spot to the optical position where position error is zero. Such a system represents the first periodic structure 108 and the subset of light spots 103 intended to be applied to said first periodic structure. The subset of light spots 103 or oriented along axis x1, while the first periodic structure 108 is oriented along axis x2. The period of the periodic structure 108 is referred to as b1.

The angle between axis x1 and axis x2 corresponds to the angular misalignment 6 between the information carrier 101 and the array of light spots 103. For sake of understanding, it is noted that the misalignment angle δ has been represented much larger than it would be in reality.

The first periodic structure 108 is oriented along axis x3, so that axis x2 and axis x3 define said first and known angle α0. The absolute value of the angle between axis x1 and axis x3 is thus defined as:

α1=|α0+δ| (1)

FIG. 7 depicts a similar partial top view as the one depicted in FIG. 5, wherein the projection of the light variation I1 of the first Moiré pattern is drawn as an example.

The first Moiré pattern results from the interference between the periodic light spots 103 and the first periodic structure 108 placed on the information carrier 101. This optical phenomenon generally occurs when an input image with a periodic structure (i.e. the periodic structure 108 in the present case) is sampled with a periodic sampling grid (i.e. the periodic array of light spots in the present case) having a period which is close or equal to that of the input image, which results in aliasing. The sampled image is magnified and rotated according to an angle which value depends on:
the ratio between the period of the input image and the period of the sampling grid,
the angular position between the input image and the sampling grid (i.e. between the periodic structure 108 and the periodic array of light spots in the present case).

If the light variation of the sampled image is projected on a given and same axis (i.e. axis x1 in the present case) to obtain a projection signal, the period of this projection signal changes when the relative angular position between the input image and the sampling grid varies (i.e. angular change between the periodic structure 108 and the periodic array of light spots 103 in the present case).

In the present case, the projection along axis x1 of the light variation of the first Moiré pattern is done by detection area 110. The detection area 110, the periodic structure 108 and the subset of light spots 103 are superimposed, but for sake of understanding, the detection area 110 is represented below.

Each partial measure M which defines the projection signal I1 may derive from the sum of partial part of the Moiré pattern detected by detection area 110. For example, a partial measure M may be derived from the sum of signals generated by a set of adjacent pixels PX4-PX5-PX6 of the detector, and so on for the definition of the other partial measures. Alternatively, a single pixel covering the surface of pixels PX4-PX5-PX6 may be defined for generating the partial measure M.

The accuracy with which the frequency of the light variation can be determined depends on the length L of the periodic structure 108.

In the present case where the data area 101 of the information carrier is made of adjacent elementary data areas, it can be set as a constraint that the accuracy of the angular measure does not exceed the size S of an elementary data areas over the full length L_{full} of the information carrier. With these conditions, it can be shown that the following relation must be verified:

b1/S=L/L_{full} (2)

For example, it can be decided to set b1=S and L=L_{full}, where S corresponds to the distance between two adjacent elementary data areas of the data area 105.

Note that if the information carrier 101 has sides of different lengths, the length L of the information carrier should be interpreted as the size of the longest side, and if the information carrier is read out in segments, the length L of the information carrier should be interpreted as the length of the segment.

It can be shown that for values of angle α1 verifying:

b/L<α1<b/2p (3)
where b is the period of the periodic structure 108,
   L is the length of the periodic structure 108,
   p is the period of the periodic array of light spots 103.
      the absolute value of angle α1 may be derived from the following relation:

sin(α1)=b.F1 (4)
where F1 is the frequency of the projection signal 11.

The measurement of the first frequency value F1 is performed by the processing means 112, for example in detecting consecutive minimums and maximums in the projection signal I1 to derive the period T1 and then F1 defined by F1=1/T1, or making an inverse Fourier Transform and taking the first harmonic as a measure of F1.

From (1), the knowledge of the absolute value of angle α1 is sufficient to derive the absolute value of angle δ. The sign of angle δ is important because it indicates in which direction the array of light spots 103 is rotated with respect to the information carrier 101, and thus in which direction the actuators AC1-AC2-AC3 have to act to cancel the angular misalignment δ.

To determine the sign of angle δ, the second Moiré pattern generated on the detection area 111 by the second periodic structure 109 is analysed similarly as the first Moiré pattern generated by the first periodic structure 108. The detection area 111, the periodic structure 109 and the subset of light spots 103 are superimposed.

FIG. 6 depicts another partial top view of the known system described in FIG. 5. It represents the second periodic structure 109 and the subset of light spots 103 intended to be applied to said second periodic structure 109.

The subset of light spots 103 is oriented along axis x1, while the second periodic structure 109 is oriented along axis x2. The period of the periodic structure 108 is also referred to as b1.

The angle between axis x1 and axis x2 corresponds to the angular misalignment 6 between the information carrier 101 and the array of light spots 103. For the sake of understanding, it is noted that the misalignment angle δ has been represented much larger than it would be in reality.

The second periodic structure 109 is oriented along axis x3, so that axis x2 and axis x3 define said second and known angle α0 opposite to that of the first periodic structure 108. The absolute value of the angle α2 between axis x1 and axis x3 is thus defined as:

α2=|α0−δ (5)

A projection of the light variation of the second Moiré pattern is done for generating a projection signal 12 (similarly as signal I1 described above) whose frequency value F2 is calculated similarly as the first frequency value F1. This allows to derive the absolute value of the angle α2 between axis x1 and axis x3:

sin(α2)=b.F2 (6)
where F2 is the second frequency value of projection signal I2.

With the knowledge of a1 and a2 derived from (4) and (6) from frequency F1 and frequency F2, respectively, the sign of angle δ may thus be derived from the relation:

sign(δ)=sign(α1−α2) (7)
where sign(δ) represents the sign of parameter δ.

Alternatively, to determine the sign of angle δ, the second periodic structure 109 may be chosen as a structure identical to the first periodic structure 108, and placed parallel to the first periodic structure 108. In this case, the sign of angle δ is given by the sign of the phase difference between the signal derived from the projection of the first Moiré pattern generated by the first periodic structure 108, and the signal derived from the projection of the second Moiré pattern generated by the second periodic structure 109.

The analysis of Moiré patterns described above applies when angles α1 and α2 are in the range [b/L, b/2p]. For example, if the parameters of the system depicted in FIG. 1 are such that b=500 nm, L=2 cm and p=15 μm, angles α1 and α2 to be measured may be in the range [2e−5, 0.017], corresponding to angles approximately between 0 and 1 degree. In this case, angle α0 is advantageously in the order of a few tenths of degree.

To be able to measure larger angles α1 and α2, and as a consequence a larger misalignment angle δ, the period b1 of the first periodic structure 108 and the second periodic structure 109 may be increased. For example, if b=p=15 μm, angles α1 and α2 to be measured may be in the range [7.5e−4, 0.5], corresponding to angles approximately between 0.04 and 30 degrees. In this case, angle α0 is advantageously in the order of a few degrees.

The servo marks in the system described above can, for instance, be placed in bands 800 that are placed at the edges of the media. Alternatively, such bands 800 may form a cross intersecting at the centre of the media 801. These example configurations are shown in FIG. 8, wherein the sensor area is determined by reference numeral 802. Note that the method disclosed above is not restricted to these particular servo mark configurations but applies more generally. It applies to the situation where the servo information is extracted by the same image sensor that is used for extraction of the bit information. Further, it applies to the situation that the servo marks only cover a relatively small percentage of the entire sensor area. Furthermore, it applies to the situation where the servo marks are not completely fragmented, i.e. divided in small marks that are spread out over the enter medium, but rather servo marks that form contiguous blocks or bands, having a rectangular shape.

A problem with extracting servo information with the same image sensor that is used for bit detection is that the refresh rate for capturing an entire image is rather low, in the order of 10 frames per second. This means that in principle, the update rate of the servo information is also in the order of 10 samples per second, for current systems. When the probes are to be moved from one readout position to the next, it takes several samples (2 or more) before the end position is reached. In other words, the servo bandwidth is limited by the refresh frequency of the image sensor, and it will be apparent that increased low servo bandwidth results in a slow readout, i.e. a low data rate for the system, which is obviously disadvantageous. High data rates are required to fulfil the requirements of applications that require a high communication bandwidth, such as video. Also, having the option of high data transfer rate would enable the drive to be operated in burst mode, which would reduce the power consumption.

### OBJECT AND SUMMARY OF THE INVENTION

It is therefore an object of the invention to provide a system and method for positioning an information carrier in an information carrier scanning system, wherein the scanning speed is significantly increased.

In accordance with the present invention, there is provided a positioning system for positioning an information carrier in an information carrier scanning apparatus, said information carrier having one or more reference structures, said information carrier scanning apparatus comprising a probe array generating means for generating a probe array comprising an array of light spots, means for applying said probe array to said information carrier so as to generate output light beams, and a sensor for receiving said output light beams, said positioning system comprising means for selecting a region of interest of said information carrier comprising a portion thereof corresponding to said one or more reference structures, narrowing the field of view of said sensor to cover only said region of interest and receiving output light beams in respect thereof and generating respective control signals and means for positioning said information carrier relative to said probe array using said control signals.

Also in accordance with the present invention, there is provided a method of positioning an information carrier in an information carrier scanning apparatus, said information carrier having one or more reference structures, and said information carrier scanning apparatus comprising a probe array generating means for generating a probe array comprising an array of light spots, means for applying said probe array to said information carrier so as to generate output light beams, and a sensor for receiving said output light beams, the method comprising selecting a region of interest of said information carrier comprising a portion thereof corresponding to said one or more reference structures, narrowing the field of view of said sensor to cover only said region of interest, receiving output light beams in respect of said region of interest and generating respective control signals, and positioning said information carrier relative to said probe array using said control signals.

Also in accordance with the present invention, there is provided an information carrier scanning apparatus for scanning an information carrier having one or more reference structures, the apparatus comprising a probe array generating means for generating a probe array comprising an array of light spots, means for applying said probe array to said information carrier so as to generate output light beams, a sensor for receiving said output light beams, means for selecting a region of interest of said information carrier comprising a portion thereof corresponding to said one or more reference structures and narrowing the field to view of said sensor to cover only said region of interest, said sensor being arranged to receive output light beams in respect of said region of interest and generate control signals therefrom, the apparatus further comprising positioning means for positioning said information carrier relative to said probe array using said control signals.

Thus, the present invention makes use of the so-called “windowing” option offered in, for example, known CMOS image sensors for increasing the scanning speed in an information carrier scanning system. This enables the speed of detection of information on the information carrier to be increased, while at the same time increasing the update rate of servo position information. Hence the servo bandwidth is increased and more rapid positioning of the scanning spots is facilitated which, in turn, results in an increased information throughput of the system.

In an exemplary embodiment, a plurality of reference structures may be provided on the information carrier, preferably in a regular pattern. The reference structures may, for example, comprise parallel and/or intersecting servo bands, which may be continuous or otherwise. In one preferred embodiment, the reference structures may comprise periodic structures intended to interfere with the probe array so as to generate one or more Moiré patterns. In an exemplary embodiment, the reference structures may comprise a first periodic structure and a second periodic structure, said first and second periodic structures being intended to interfere with said probe array for generating a first Moiré pattern and a second Moiré pattern, respectively, and analysis means may be provided for deriving from the first and second Moiré patterns, the angle value between the probe array and the information carrier, the control signals being derived from said angle value.

The information on the information carrier is beneficially defined by transparent and non-transparent areas in the data layer of the information carrier, such that the output light beams generated by applying the probe array to the data layer are representative of the transparent areas and are transmitted to said sensor for conversion into binary data. Alternatively, however, the data may be coded according to a multilevel approach. The information carrier may, for example, comprise a static information carrier (or “optical card”) intended to store binary (or multilevel) data organised in a data matrix. Alternatively, the information of the information carrier may be a sample to be imaged, such as biological cells to be imaged by a microscope.

These and other aspects of the invention will be apparent from, and elucidated with reference to, the embodiment described herein.

### BRIEF DESCRIPTION OF THE DRAWINGS

An embodiment of the present invention will now be described by way of example only, and with reference to the accompanying drawings, in which:

FIG. 1 depicts a system for reading an information carrier;

FIG. 2 depicts an optical element dedicated to generate an array of light spots;

FIG. 3 depicts a detailed view of said system for reading an information carrier;

FIG. 4 illustrates by an example the principle of macro-cell scanning of an information carrier;

FIG. 5 depicts a first partial top view of the system of FIG. 1;

FIG. 6 depicts a second partial top view of the system of FIG. 1;

FIG. 7 illustrates the generation and detection of a Moiré pattern;

FIG. 8 illustrates schematically an exemplary layout of servo marks on an information carrier; and

FIG. 9 illustrates schematically the use of the windowing option offered by the image sensor to define a region of interest around a servo band.

### DETAILED DESCRIPTION OF THE INVENTION

It is proposed herein to make use of the so-called windowing option in, for example, known CMOS sensors for increasing the readout speed of the reading system described above. However, it will be appreciated that the present invention is not necessarily limited to CMOS sensors per se, but extends to all sensors that offer the above-mentioned windowing option.

Windowing is the general term used for narrowing the area that is transferred to the A/D converter on an image sensor. CMOS (Complementary Metal Oxide Semiconductor) is a well-known technology for capturing images digitally. A CMOS image sensor comprises a pixelated metal oxide semiconductor which accumulates signal charge in each pixel, proportional to the local illumination intensity.

A CMOS sensor converts the charge to voltage within each pixel. CMOS sensors use an array of photodiodes to convert light into electronic signals. The electronic charge that is generated by the photodiode is too weak and needs amplifying to a usable level. For this purpose, each pixel in a CMOS sensor has its own amplifier circuit to perform pre-scan signal amplification. The resulting signal is strong enough to be used without any further processing. CMOS sensors often contain additional image processing circuitry—including analog-to-digital converts and digital image signal processors (ISPs) on the chip itself, making it easier and faster to retrieve and process picture information. This results in a lower chip count, increased reliability, reduced power consumption, and a more compact design.

As is well known, a unique capability of CMOS technology (compared with CCD technology) is the ability to read out a portion of the image, providing for the display of specific regions image. This is known as “windowing”.

Current CCD sensors are not capable of using this since the underlying technology is not suited for it. CMOS image sensors on the other hand do support it. A user definable rectangle 900 can be defined around a servo band 800 and selected for read-out, e.g. as shown in FIG. 9. The image sensors information in this rectangle is transferred to the A/D converter (not shown). Depending on the size of the rectangle 900 compared to the complete image sensor area 802 gives the refresh rate of the readout can be increased.

For example, if the refresh rate for capturing an entire frame is 10 fps, then the refresh rate for capturing only the top half of the frame is 20 fps. Suppose for instance that a servo mark in the T-ROM system is placed in the upper 5 lines of a CMOS sensor with 1000 lines, then the corresponding region of interest can be readout at 200 times the speed needed to read out the entire frame. With such a high update rate the positioning speed of the servo system can, in principle, be increased by a factor 200. This in turn means that also the readout speed of the system can be increased.

Let suppose for instance that the refresh rate for capturing an entire image is 10 fps, hence the interval between captures is 0.1 second. Suppose further that 3 sampling steps are needed in order to move the probe array to the next data page position. Then, for example that the servo mark covers only 5 out of 1000 lines, the total time needed for repositioning the probe array and reading out a page will be 3*0.0005+0.1=0.105 seconds, whereas it would have taken 3*0.1+0.1=0.4 seconds in the no-windowing situation.

It is envisioned that an exemplary servo system uses image sensor areas that are not effectively captured within one rectangle creating the need to do multiple windowing actions within one image integration time. This creates some communication overhead in order to read-out multiple rectangles per image integration time proportional to the number of rectangles to be read. It is further proposed to use an image sensor that supports multiple windowing (per image integration time) in order to further increase the servo update rate.

Multiple windowing (within one integration time) can mean a number of things, including the fact that using a single window that is reconfigured and read-out multiple times (requires multiple reconfigurations from a host system via a relatively slow interface therefore decreasing the time gain).

Thus, it is proposed herein to make use of the windowing option of, for example, CMOS image sensors, in order to speed up the detection of servo marks in an information carrier reading system of the type described above.

By this method, the update rate of the servo position information, and hence the servo bandwidth can be increased. This will allow a more rapid positioning of the read-out spots, resulting in an increased data throughput of the system.

The positioning system in accordance with the invention may be used in a microscope. Microscopes with reasonable resolution are expensive, since an aberration-free objective lens with a reasonably large field of view and high enough numerical aperture is costly. Scanning microscopes solve this cost issue partly by having an objective lens with a very small field of view, and scanning the objective lens with respect to the sample to be measured (or vice-versa). The disadvantage of this single-spot scanning microscope is the fact that the whole sample has to be scanned, resulting in cumbersome mechanics. Multi-spot scanning microscopes solve this mechanical problem, since the sample does not have to be scanned over its full dimensions, the scanning range is limited to the pitch between two spots.

In a microscope in accordance with the invention, a sample is illuminated with the spots that are created by the probe array generating means, and a camera takes a picture of the illuminated sample. By scanning the spots over the sample, and taking pictures at several positions, high-resolution data are gathered. A computer may combine all the measured data to a single high-resolution picture of the sample. The positioning system in accordance with the invention allows to increase the servo bandwidth, resulting in overall increase in the speed of imaging a sample.

The focus distance can be controlled manually, by looking at a detail of the picture of the sample. It can also be performed automatically, as is done in a digital camera (finding the position in which the picture has the maximum contrast). Note that the focusing of the imaging system is not critical, only the position of the sample with respect to the probes is important and should be optimized.

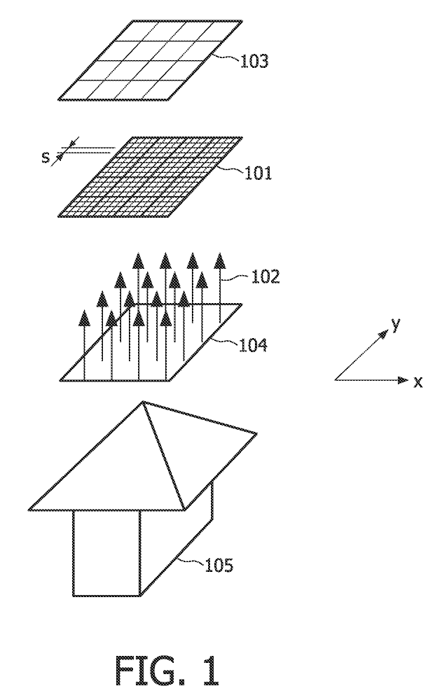

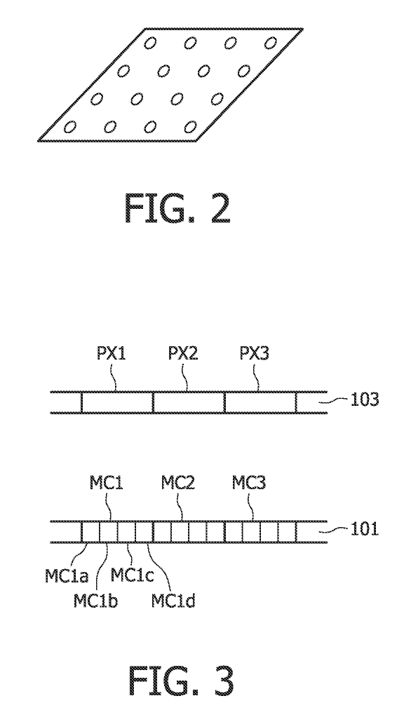

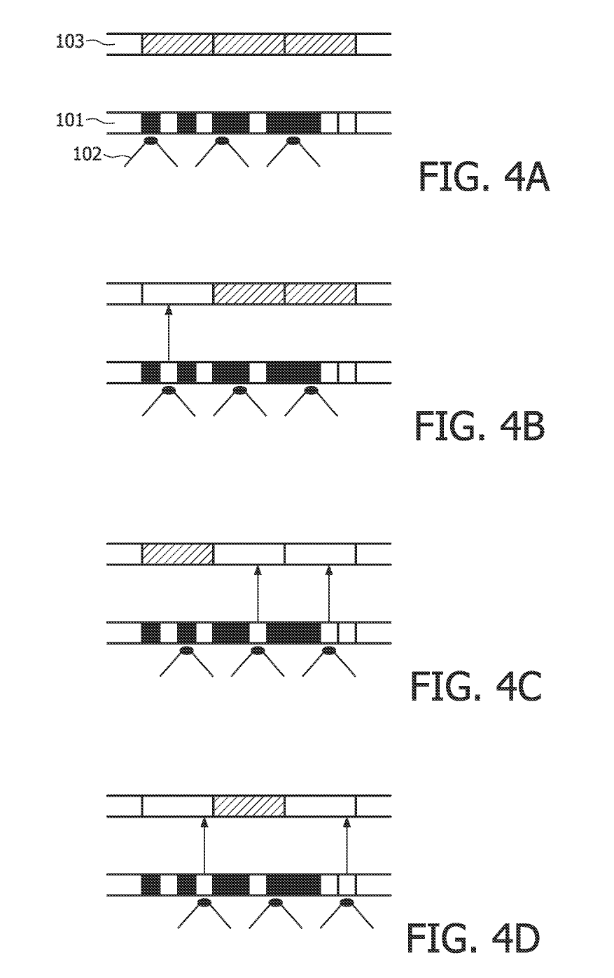

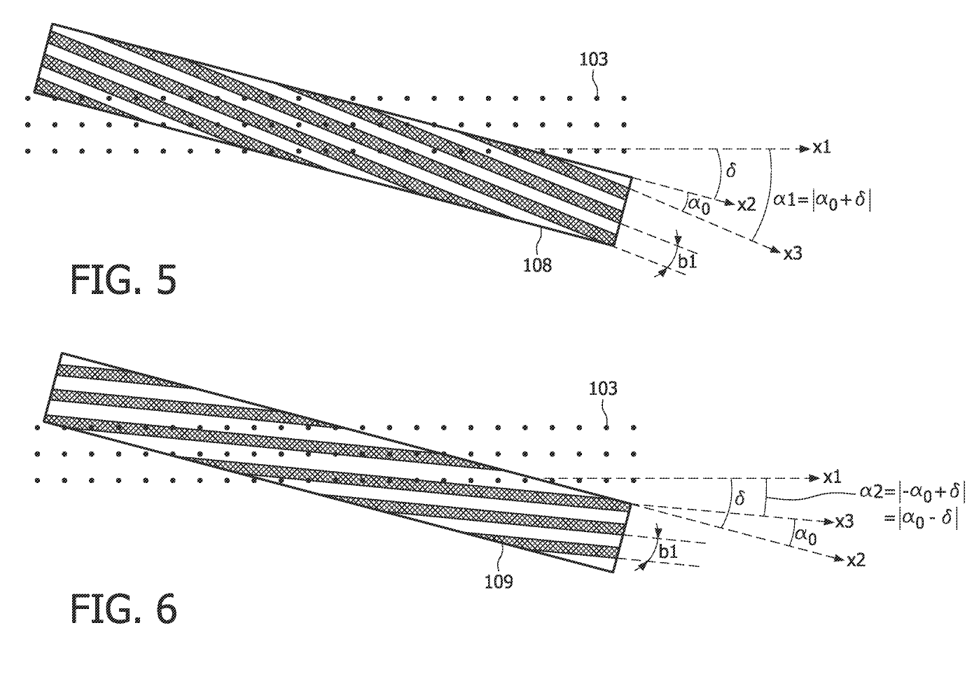

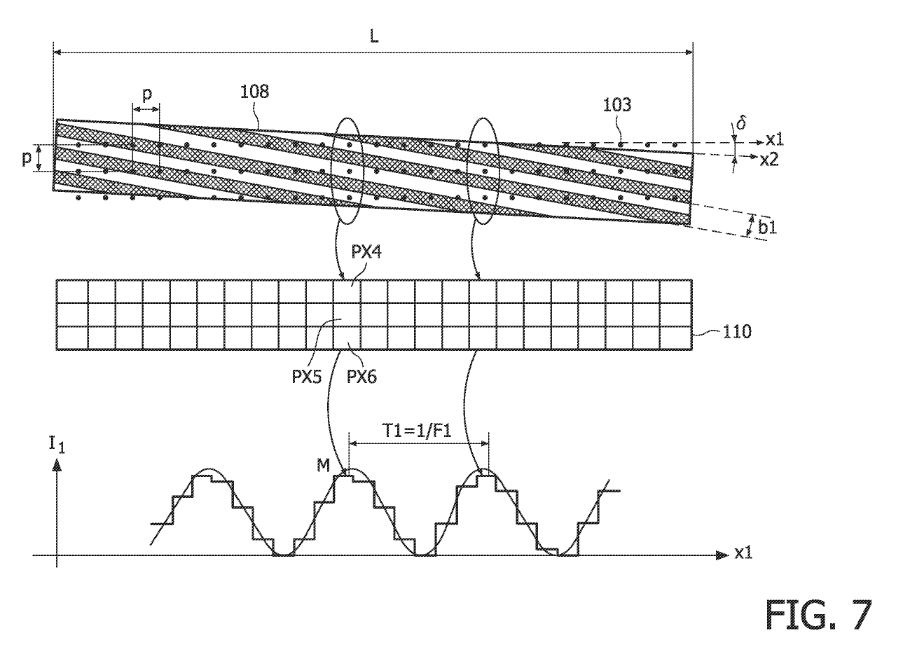

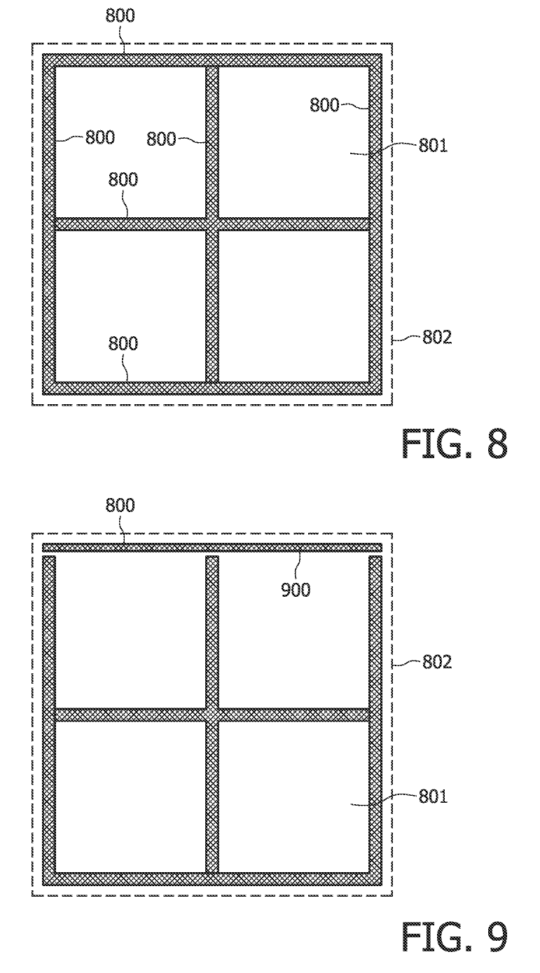

A microscope in accordance with the invention consists of an illumination device, a probe array generator, a sample stage, optionally an imaging device (e.g. lens, fiber optic face plate, mirror), and a camera (e.g. CMOS, CCD). This system corresponds to the system of FIG. 1, wherein the information carrier (101) is a microscope slide on which a sample to be imaged may be placed, the microscope slide being deposited on a sample stage. The microscope slide comprises reference structures such as structures represented in FIG. 5, which may be placed in bands on the information carrier, such as bands 800 of FIG. 8. The data sample is placed on the information carrier at a location where there is no reference structure.

Light is generated in the illumination device, is focused into an array of foci by means of the probe array generator, it is transmitted (partly) through the sample to be measured, and the transmitted light is imaged onto the camera by the imaging system. The sample is positioned in a sample stage, which can reproducibly move the sample in the focal plane of the foci and perpendicular to the sample. In order to image the whole sample, the information carrier is scanned so that all areas of the sample are imaged by an individual probe. The positioning servo is performed by means of the reference structures and the windowing process as described hereinbefore.

Instead of a transmissive microscope as described above, a reflective microscope may be designed. In a reflective microscope in accordance with the invention, light that has passed through the sample is reflected by a reflecting surface of the microscope slide and then redirected to the camera by means of a beam splitter.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A system for positioning an information carrier (801) in an information carrier scanning apparatus, said information carrier having one or more reference structures, said reading apparatus comprising
a probe array generating means (104) for generating a probe array comprising an array of light spots (102),
means for applying said probe array (102) to said information carrier (801) so as to generate output light beams,
a sensor (103) for receiving said output light beams,
said system comprising:
means for selecting a region of interest (900) of said information carrier (801) comprising a portion thereof corresponding to said one or more reference structures (800) narrowing the field of view (802) of said sensor (103) to cover only said region of interest (900) and receiving output light beams in respect thereof and generating respective control signals,
means for positioning said information carrier (801) relative to said probe array (102) using said control signals.

2. A scanning apparatus for scanning an information carrier (801) having one or more reference structures (800), the scanning apparatus comprising:
a probe array generating means (104) for generating a probe array comprising an array of light spots (102),
means for applying said probe array to said information carrier (801) so as to generate output light beams, a sensor (103) for receiving said output light beams,
means for selecting a region of interest (900) of said information carrier (801) comprising a portion thereof corresponding to said one or more reference structures (800) and narrowing the field of view (802) of said sensor (103) to cover only said region of interest (900), said sensor (103) being arranged to receive output light beams in respect of said region of interest (900) and generate control signals therefrom,
means for positioning said information carrier (801) relative to said probe array (102) using said control signals.

3. A system according to claim 1, wherein a plurality of reference structures (800) are provided on the information carrier (801).

4. A system according to claim 3, wherein said plurality of reference structures (800) are provided in a regular pattern.

5. A system according to claim 4, wherein the reference structures comprise parallel and/or intersecting servo bands.

6. A system according to claim 1, wherein the reference structures (800) comprise periodic structures (108, 109) intended to interfere with the probe array (102) so as to generate one or more Moiré patterns.

7. A system according to claim 6, wherein the reference structures (800) comprise a first periodic structure (108) and a second periodic structure (109), said first and second periodic structures (108, 109) being intended to interfere with said probe array (102) for generating a first Moiré pattern and a second Moiré pattern, respectively, said system further comprising analysis means for deriving from said first and second Moiré patterns the angle value between the probe array (102) and the information carrier (801) the control signals being derived from said angle value.

8. A system according to claim 1, wherein the data set is defined by transparent and non-transparent areas in the data layer of the information carrier (801).

9. A system according to claim 1, wherein the information carrier (801) comprises a static information carrier intended to store binary or multilevel data organized in a data matrix.

10. A method of positioning an information carrier (801) in a scanning apparatus, said information carrier (801) having one or more reference structures (800), said information carrier scanning apparatus comprising a probe array generating means (104) for generating a probe array comprising an array of light spots (102), means for applying said probe array (102) to said information carrier (801) so as to generate output light beams, and a sensor (103) for receiving said output light beams, the method comprising the step of:
selecting a region of interest (900) of said information carrier (801) comprising a portion thereof corresponding to said one or more reference structures (800) narrowing the field of view (802) of said sensor (103) to cover only said region of interest (900),
receiving output light beams in respect of said region of interest (900) and generating respective control signals,
positioning said information carrier (801) relative to said probe array (102) using said control signals.

11. A microscope comprising a system as claimed in claim 1.
